(19) United States
(12) Patent Application Publication
(10) Pub. No.: US 2011/0034840 A1
(43) Pub. Date: Feb. 10, 2011

(54) SELF-CHARGING CONTOURABLE INFLATABLE BLADDER

(76) Inventors: Thomas (aka T Addison) Broun (Wells), Beverly Hills, CA (US); Jorge H. Aspron, Los Angeles, CA (US)

Correspondence Address: LAUSON & TARVER LLP, 880 APOLLO STREET, SUITE 301, EL SEGUNDO, CA, 90245, US

(21) Appl. No.: 12/905,986

(22) Filed: Oct. 15, 2010

Related U.S. Application Data
(63) Continuation-in-part of application No. 11/701,625, filed on Feb. 2, 2007, now abandoned.

(51) Int. Cl. A61H 9/00

(52) U.S. Cl. 601/152

(57) ABSTRACT

A low-profile self-charging and contouring bladder system assists circulation in a treatment region. Bladders capable of self-inflation and deflation incorporate entry and exit check valves having predetermined cracking pressures to maintain internal pressure above the ambient pressure of the ambient environment. Recharging check valves having low cracking pressures at or slightly above atmospheric pressure, combined with the self-inflation properties of the bladders promotes bladder pressurization. Bladders are disposed in sleeves designed to fit various parts of a wearer's body, and connected in series to allow the apparatus to work across a large region. The system is designed at pressures so that normal bodily movement, including skeletal bending and twisting, causes bladders to expel fluid and take in fluid in a manner causing pressure waves to move across the treatment region.

This application is a continuation in part of application Ser. No. 11/701,625 entitled “Self Actuating Sequential & Gradient Compression Apparatus,” filed Feb. 2, 2007, now abandoned.

### BACKGROUND

Many venous ailments such as result from diabetes or lymph and other types of edema often result in poor circulation which adversely affect quality of life, can result in gangrene, resulting in amputation, and may eventually may become life threatening over time. One method of treatment is to apply elastic compression garments or compression bandaging to force fluids through the body under static pressure. A more advanced technique involves sequential gradient pump therapy wherein overlapping cells promote movement of fluids. Current sequential pump devices in the art typically include powered systems which are elaborate. Users of such systems are unable to engage in normal activities during operation of the device. Importantly, this prevents such devices from being used as a preventative treatment.

There is therefore needed a self-charging apparatus capable of carrying out sequential pump therapy that allows patients to engage in normal activities while the apparatus is in use. There is also a need for an apparatus that avoids problems associated with bladder leakage and recharging, and which can be adapted to large areas of the body and its extremities. It is therefore among the objects of the present apparatus to provide a self-contained, self-recharging, and modular inflatable bladder system to provide sequential pump therapy to areas of a user's body, while allowing the user to pursue normal activities and movement. In addition to circulatory improvement, it is anticipated that the apparatus will improve climate control when combined with articles of clothing, and will result in improved comfort and safety in prosthetic sockets.

### SUMMARY

An apparatus is disclosed for applying waves of fluid pressure to an area of a user's body using the user's own bodily movements to generate the pressure, including vector forces generated from bending movement. The apparatus includes a resilient bladder of a predetermined volume. The bladder has an entry check valve for fluid ingress, an exit check valve for fluid egress, and a recharging check valve for ingress of ambient fluid surrounding the bladder. In an exemplary embodiment, the fluid is air. A means for bearing the bladder against the user's body causes the bladder to apply pressure against the area.

The bladder is adapted to deform responsive to a user's bodily movements, reducing the volume of the bladder, and elastically reform. To assist in the reforming process, a compressible extruded elastic member is incorporated into the bladder, helping to re-inflate the bladder after deformation. In one embodiment, the bladder is generally tube shaped and adapted to deform between 0.25 and 1 inch when compressed, thereby allowing the bladder to maintain a low profile as it fills with fluid. In bladders of this configuration, the extruded elastic member may include a series of fins radiating from a central axis.

The bladder tubing is configured so that fluid movement generates a pressure wave moving from the treatment area toward a user's torso to assist normal circulation. Such a configuration may include several interconnected bladder tubes or a single tube arranged in a predetermined pattern such as a “S” shape.

To apply pressure toward the area of the user's body, the bladder may be constructed to have a more elastic first surface adjacent the area, and a substantially inelastic second surface. In this manner, the side of the bladder facing the area to be treated deforms and reforms to a greater extent than the side of the bladder facing away from the user. The fins of the elastic extruded member should conform to the shape of the bladder when inflated to maximize reforming speed.

The bladder has an entry check valve, an exit check valve and a recharging check valve in communication with the bladder's ambient environment. The exit check valve has a cracking pressure between 0 and 0.58 psi, and the recharging check valve has a cracking pressure above 0 psi. It is also anticipated that the bladder may include internal check valves to govern fluid movement within a single compartmentalized bladder.

Due to the recharging check valve's low cracking pressure, any vacuum pressure in the reforming bladder greater than ambient environmental fluid pressure urges ambient fluid into the bladder. In this manner, fluid entering and exiting the bladder through the check valves generates pressure waves across the area as a user engages in normal bodily movement. It is also desirable, although not necessary to have recharging check valves located inside the bladder along its tubular length to urge fluid and a corresponding pressure wave across the bladder in one direction.

As the bladder is charged by virtue of a user's bodily movements, pressure builds in the bladder until the cracking pressure of its exit valve is reached, at which point the bladder expels the fluid, reducing pressure against the exit valve. This process repeats, causing a constant stream of downstream pressure waves moving in a single direction. One advantage of this arrangement is that multiple bladders may be in fluid communication and connected in series by having the exit check valve of a first bladder serve as the entry check valve of a second bladder downstream from the first.

Bodily circulation is best encouraged when the greatest pressure is exerted at the ends of the extremities, and successively lower pressures exerted toward a user's torso. In order to accomplish this goal, and to ensure bladders connected in series urge circulation in the proper direction, the bladders are preferably adapted to develop successively lower pressure waves from one bladder to the next as the bladders approach a user's torso.

The apparatus is designed to have a maximum operational pressure of 0.58 psi, as pressures above this level may be harmful. In order to prevent the bladder, or series of bladders, from over pressurizing, an exhaust or safety check valve may be incorporated having a cracking pressure of between 0.58 and 1.0 psi. Further, in another exemplary embodiment, the final exit check valve in a series of bladders may be connected to a channel leading to the entry check valve of the first bladder in the series. In this manner, air exiting the last bladder will be immediately transferred to the first bladder, ensuring the continuity of pressure waves along the device.

It is anticipated that a variety of check valves having the prescribed cracking pressures may be used in the apparatus. One exemplary embodiment that is contemplated includes a check valve having a tube with a seat and opening. The check in such a valve includes a spheroid shape adapted to block the valve's seat. Also included in the tube is a series of opposing and parallel helical steps, the steps being adjacent the opening and downstream from the check. The check also includes a retaining rod attached to the spheroid by a filament, adapted to engage the helical steps. By disposing the retaining rod on a pair of steps farther up or down the tube, the strength of the check valve can be set to an optimal pressure.

More fluid pressure is required to dislodge the spheroid from the seat when the retaining rod is set closer to the seat, and less pressure is required when the retaining rod engages steps closer to the tube opening due to the rigidity of the material comprising the valve. It is anticipated that the tube may be made of a rigid thermoplastic material, or thermoset material, while the spheroid is elastomeric. In an exemplary embodiment, medical grade polymers are used to construct the check valves.

Having provided the bladder system for urging waves of fluid pressure along the treatment area using entry, exit and recharging check valves, it may be necessary to provide a support structure adapted to preserve the bladder adjacent to and bearing against the treatment area. A sleeve is contemplated into which a bladder may be incorporated. In an exemplary embodiment, the sleeve is substantially tube shaped, surrounding a portion of the user's body and applying the bladder thereto. The bladder may extend partially or wholly around the inside of the sleeve. It is anticipated that bladders connected in series may be incorporated into either a series of sleeves, or into a single sleeve capable of holding several bladders.

To assist the bladder in providing the waves of fluid pressure, the sleeve ideally is constructed of a material making it circumferentially inelastic and longitudinally elastic. The selective elasticity of the sleeve is adapted to modify the pressure waves generated by the apparatus, intensifying them in appropriate areas. In addition to the sleeve material applying the bladder to the treatment area, the sleeve also comprises a material between the bladder and the treatment area permitting the assembly to be easily attached and removed, and when worn, to prevent the bladder or bladders from binding the user's skin.

In order to use the apparatus, a sleeve containing at least one elastic bladder is placed over the treatment area. In an exemplary embodiment, an extremity such as an arm may be slid into the sleeve in a manner similar to a conventional article of clothing. As the sleeve reaches the treatment area, and the user begins to engage the area in skeletal movements, pressure on a bladder between the sleeve and the user's body causes the bladder to deform and reform, thereby causing fluid to move through the bladder. As bladder pressure meets the cracking pressure of an exit check valve, fluid moves downstream into another bladder, equalizing bladder pressure, completing the cycle.

Cycles of bladder pressurization and depressurization cause pressure waves to move over the treatment area in a pattern designed to urge circulation of the user's internal fluids. By connecting bladders in series with bladders of the greatest cracking pressure first, and bladders of gradually lower cracking pressure downstream from the first bladder, a user's internal fluids are directed toward the user's torso.

### BRIEF DESCRIPTION OF THE FIGURES

FIG. 1 shows a single bladder having entry, exit and recharging check valves.

FIG. 2 shows a single bladder having interconnected tubes.

FIG. 3 shows a single bladder having a single tube configured in an “S” shape.

FIG. 4 shows an elastic extruded member having fins to re-inflate a bladder.

FIG. 5 shows an array of bladders in fluid connection and arranged in series.

FIG. 6 shows a bladder array in a closed-loop system.

FIG. 7 shows a cross section of a check valve.

FIG. 8 shows a cross section of a check valve rotated 90 degrees.

FIG. 9 shows a bladder incorporated into a sleeve.

FIG. 10 shows a series of sleeves adapted to connect together.

FIG. 11 shows an apparatus having multiple sleeves adapted to treat a user's arm.

### DESCRIPTION

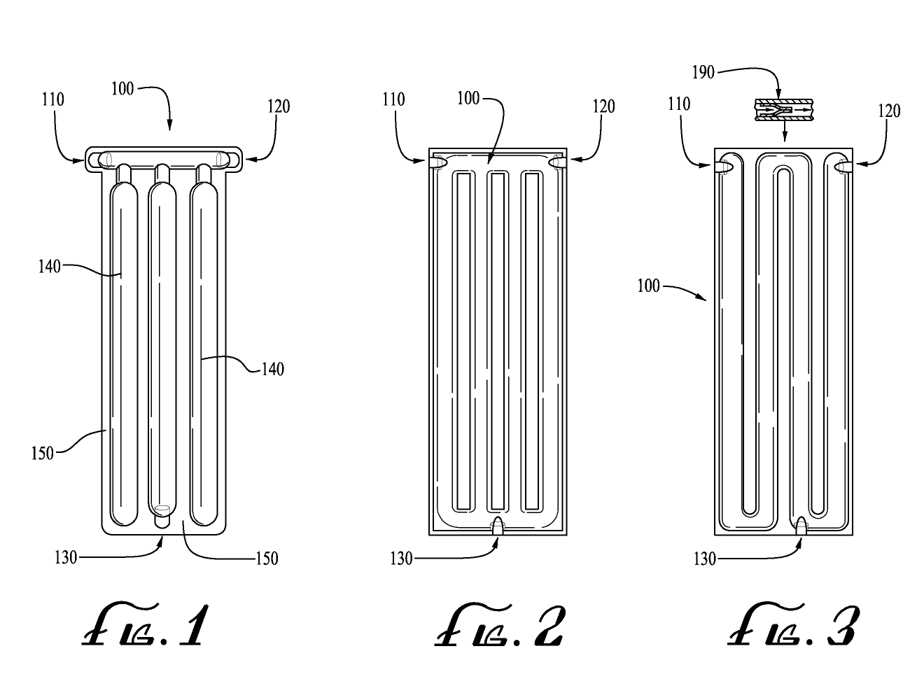

Referring to FIG. 1, a resilient bladder 100 of a predetermined volume has an entry check valve 110 for fluid ingress, an exit check valve 120 for fluid egress, and a recharging check valve 130 for ingress of ambient fluid surrounding the bladder 100. In an exemplary embodiment, the fluid is air. In another exemplary embodiment, the bladder 100 is generally tube-shaped and adapted to deform between 0.25 and 1 inch when compressed, thereby allowing the bladder 100 to maintain a low profile as it refills.

Still referring to FIG. 1, to apply pressure toward the area of the user's body, the bladder 100 may be constructed to have a more elastic first surface 140 adjacent the area, and a substantially inelastic second surface 150. In this manner, the first surface 140 side of the bladder 100 facing the area to be treated deforms and reforms to a greater extent than the second surface 150 side of the bladder 100 facing away from the user.

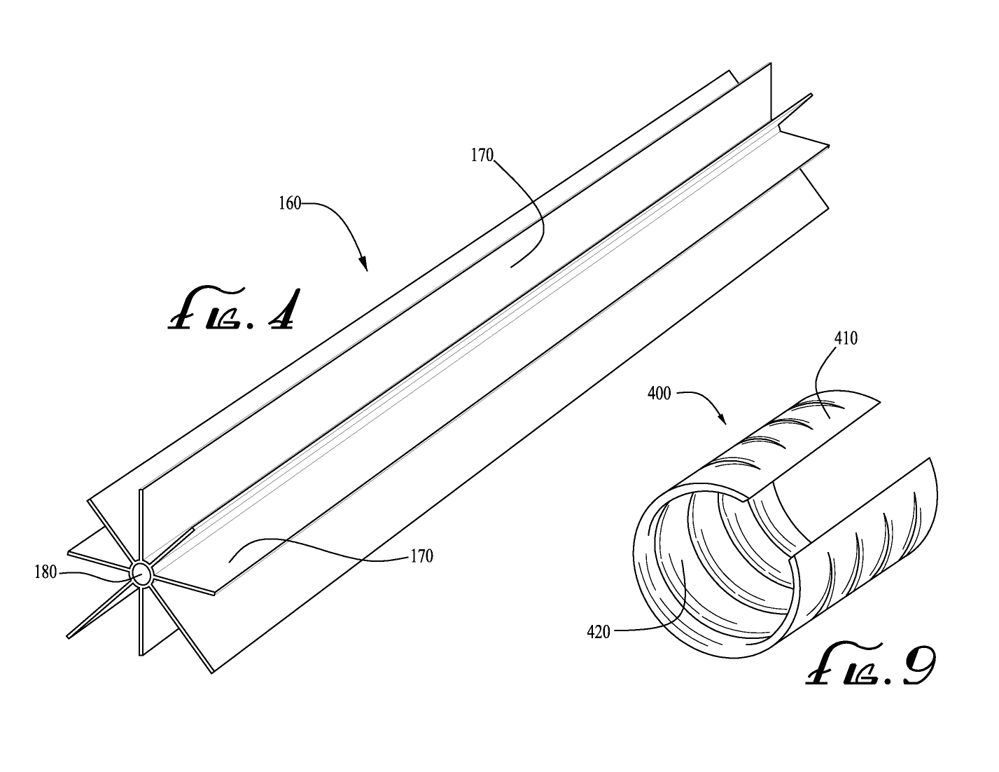

Referring to FIGS. 2 and 3, the bladder 100 tubing is configured so that fluid movement generates pressure waves to assist normal circulation. Such a configuration may include several interconnected bladder 100 tubes as shown in FIG. 2, or a single bladder 100 tube arranged in a predetermined pattern such as an “S” shape as shown in FIG. 3. It is also anticipated that bladders may be tacked to an inelastic surface, allowing them to completely inflate relative to the inelastic surface. In this arrangement, the bladders are positioned so that when deflated, there is no overlap between the bladders to preserve the low profile of the apparatus.

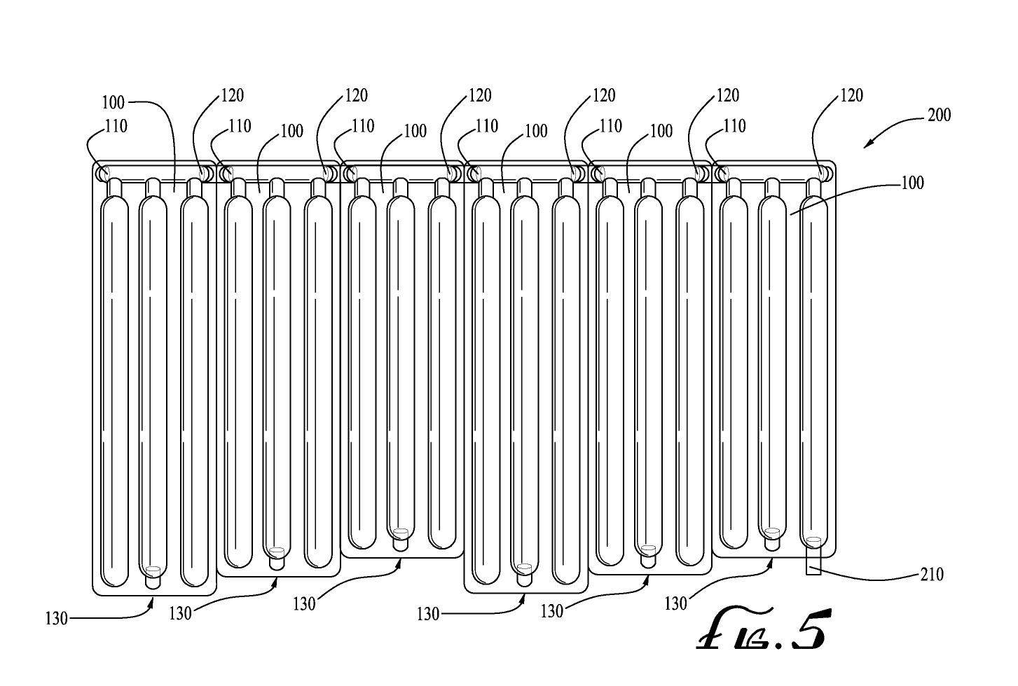

Referring to FIG. 4, an extruded member 160 assists in reforming the bladder 100 once compressed. The extruded member 160 is compressible and elastic, helping to re-inflate the bladder 100 after deformation. In bladders 100 having a tube shape, the extruded elastic member 160 may include a series of fins 170 radiating from a central axis 180. In cases where the bladder 100 has a first side 140 that deforms to a greater extent than the second side 150, the fins 170 of the elastic extruded member 160 should conform to the shape of the bladder 100 when inflated by selectively altering the length of the fins 170. The strength of the extruded member 160 may be determined by the thickness of the fins 170. It is anticipated that a variety of resilient porous elastic materials may be used in place of the extruded member 160.

Still referring to FIG. 1, the bladder 100 has an entry check valve 110, an exit check valve 120 and a recharging check valve 130 in communication with the bladder's 100 ambient environment. The exit check valve 120 has a cracking pressure between 0 and 0.58 psi, and the recharging check valve 130 has a cracking pressure above 0 psi. As shown in FIG. 3, it is also anticipated that the bladder 100 may include internal check valves 190 to govern fluid movement within a single compartmentalized bladder 100.

Due to the recharging check valve's 130 low pressure, any vacuum pressure in the reforming bladder 100 greater than ambient environmental fluid pressure urges ambient fluid into the bladder 100 assisting re-inflation. In this manner, fluid entering and exiting the bladder 100 through the entry 110 and exit 120 check valves generates pressure waves across the area as a user engages in normal bodily movement. As mentioned above, it is also possible to have recharging check valves 190 located inside the bladder 100 along its tubular length to urge fluid and the corresponding pressure wave across the bladder 100 in one direction.

As the bladder 100 is charged by virtue of a user's bodily movements, bending and flexing, pressure builds in the bladder 100 until the cracking pressure of its exit valve 120 is reached, at which point, the bladder 100 expels the fluid, reducing pressure in the exit 120 valve. This process repeats, causing waves of repeated downstream pressure moving in a single direction through the bladder 100. One advantage to this arrangement is that multiple bladders 100 may be in fluid communication and connected in series by having the exit check valve 120 of a first bladder serve as the entry check valve 110 of a second bladder 100 downstream from the first bladder 100.

Referring to FIG. 5, a series of bladders 100 are connected in series to form a bladder array 200 adapted to cover a larger treatment area. As shown in the drawing, adjacent bladders 100 share entry 110 and exit 120 check valves. Each bladder 100 also incorporates a recharging check valve 130, to allow any of the bladders 100 to recharge individually.

Bodily circulation is best encouraged when the greatest pressure is exerted at the ends of the extremities, and successively lower pressures exerted toward a user's torso. In order to accomplish this goal, and to ensure bladders 100 connected in series 200 urge circulation in the proper direction, the bladders 100 are preferably adapted to develop successively lower pressure waves from one bladder 100 to the next as the bladders 100 approach a user's torso.

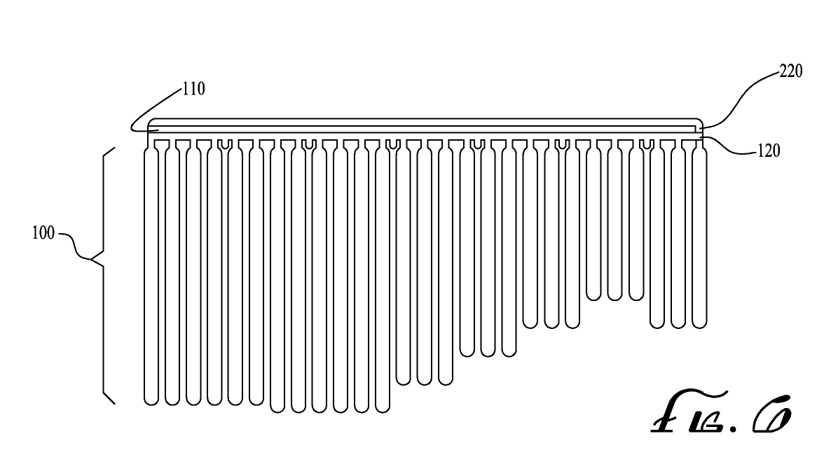

The apparatus is designed to have a maximum operational pressure of 0.58 psi, as pressures above this level may be harmful. In order to prevent a bladder 100 or series 200 of bladders, from over pressurizing, an exhaust or safety check valve 210 may be incorporated into the series 200 having a cracking pressure of between 0.58 and 1.0 psi. In any event, pressure in the apparatus should never exceed 5.0 psi. Referring to FIG. 6, in one exemplary embodiment, the final exit check valve 120 in a series of bladders 100 may be connected to a channel 220 leading to the entry check valve 110 of the first bladder 100 in the series. In this manner, air exiting the last bladder 100 will be immediately transferred to the first bladder 100, ensuring the continuity of pressure waves along the device.

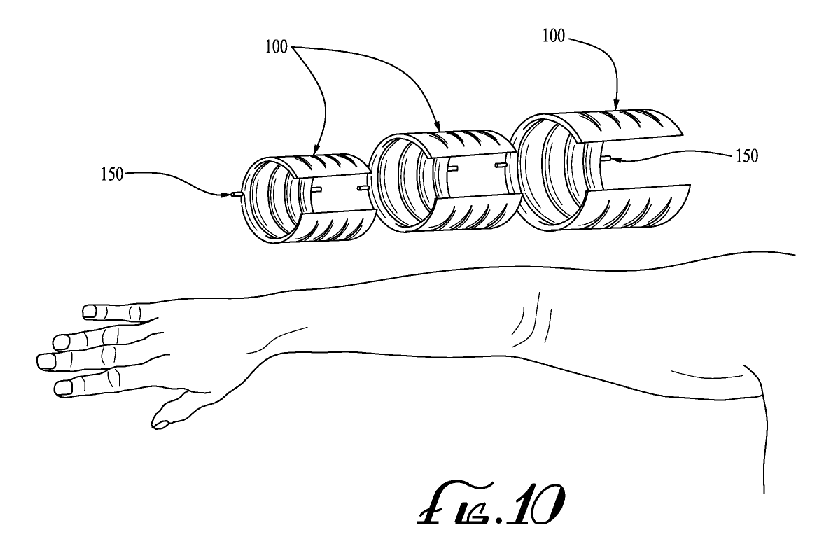

It is anticipated that a variety of check valves having the prescribed cracking pressures may be used in the apparatus. Referring to FIGS. 7 and 8, one exemplary embodiment includes a check valve 300 having a tube 305 with a seat 310 and opening 315. The check 325 in such a valve 300 includes a spheroid 330 adapted to engage the seat 310. Also included in the tube 305 is a series of opposing and parallel helical steps 320, the steps 320 being adjacent the opening 315 and upstream from the check 325. The check 325 also includes a retaining rod 350 attached to the spheroid 330 by a tensile filament 360, adapted to engage the helical steps 320. By engaging the retaining rod 350 against a given pair of helical steps 320, the strength of the check valve 300 can be set to an ideal pressure, as the tensile filament 360 will exert more or less pressure on the spheroid 330, anchoring it closed in the check 325.

Less fluid pressure is required to dislodge the spheroid 330 from the seat 310 when the retaining rod 350 is set closer to the seat 310, and more pressure is required when the retaining rod 350 engages the helical steps 320 closer to the tube 305 opening due to the greater tensile load on the filament 360, and pressure of the spheroid 330 against the material comprising the valve 300. It is anticipated that the tube 305 may be made of a rigid thermoplastic material, or thermoset material, while the spheroid 330 is elastomeric. In an exemplary embodiment, medical grade polymers are used to construct the check valves 300.

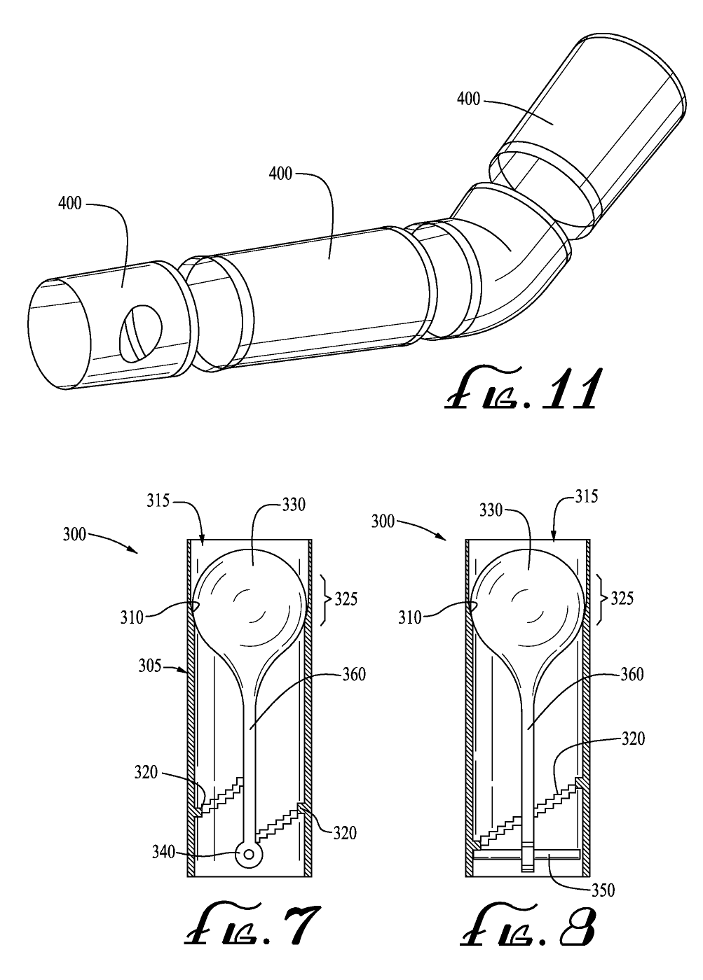

Having provided the bladder 100 or series 200 of bladders 100 for urging waves of fluid pressure along the treatment area using entry 110, exit 120 and recharging 130 check valves, it may be necessary to provide a support structure adapted to preserve the bladder 100 adjacent to and bearing against the treatment area. Referring to FIG. 9, a sleeve 400 is shown into which a bladder may be incorporated. In an exemplary embodiment, the sleeve 400 is substantially tube shaped, adapted to surround a portion of the user's body and apply the bladder 100 thereto. The bladder 100 may extend partially or wholly around the inside of the sleeve 400. It is anticipated that bladders 100 connected in series 200 may be incorporated into either a series of sleeves 400 as shown in FIG. 10, or into a single sleeve 400 capable of holding several bladders 100.

To assist the bladder in providing the waves of fluid pressure, the sleeve 400 is ideally constructed of a first material 410 making it substantially circumferentially inelastic and longitudinally elastic. The selective elasticity of the sleeve 400 is adapted to modify the pressure waves generated by the apparatus, intensifying them in appropriate areas. In addition to the first sleeve material 410 forcing the bladder against the treatment area, the sleeve 400 also comprises a second material 420 between the bladder and the treatment area permitting the assembly to be smoothly put on and taken off, and when worn, to prevent the bladder 100 or bladder series 200 from binding the user's skin.

As shown in FIG. 11, a series of sleeves 400 may be arranged in series and fluidly connected. In order to use the apparatus, a sleeve 400 containing at least one elastic bladder 100 is placed over the treatment area. In an exemplary embodiment, an extremity such as an arm may be slid into the sleeve in a manner similar to a conventional article of clothing. It is also contemplated that the sleeve may be incorporated into a conventional article of clothing. As the sleeve 400 reaches the treatment area, and the user begins to engage the area in skeletal movements, pressure on a bladder 100 between the sleeve 400 and the user's body causes the bladder 100 to deform and reform, causing fluid to move through the bladder 100. As bladder pressure meets the cracking pressure of an exit check valve 120, fluid moves downstream into another bladder, equalizing bladder 100 pressure, completing the cycle.

Cycles of bladder 100 pressurization and depressurization case pressure waves to move over the treatment area in a pattern designed to increase circulation of the user's internal fluids. By connecting bladders 100 in series 200 with bladders 100 of the greatest cracking pressure first, and bladders 100 of gradually lower cracking pressure downstream from the first bladder 100, a user's internal fluids are directed toward the user's torso.

While the present invention has been described with regards to a particular embodiment, it is recognized that additional variations of the present invention may be devised by persons skilled in the art without departing from the inventive concepts disclosed herein.

What is claimed is:

1. An apparatus for applying fluid pressure to a treatment area of a user's body using bodily movement to generate said pressure, the apparatus comprising:
a resilient bladder having a volume, an entry check valve for fluid ingress, an exit check valve for fluid egress, and a recharging check valve for ingress of an ambient fluid surrounding the bladder;
a means for bearing the bladder against the treatment area;
the bladder adapted to deform responsive to the bodily movement thereby reducing the volume, and elastically reform;
the exit check valve having a cracking pressure between 0 and 0.58 psi; and
the recharging check valve having a cracking pressure less than the exit check valve, whereby the fluid entering and exiting the bladder due to the bodily movement generates waves of pressure across the treatment area.

2. The apparatus of claim 1 wherein the bladder elastically reforming creates vacuum pressure.

3. The apparatus of claim 1 wherein the bladder has a first surface bearing against the treatment area and a substantially inelastic second surface opposite the first surface.

4. The apparatus of claim 1 wherein multiple bladders are in fluid communication in series.

5. The apparatus of claim 4 wherein the multiple bladders connected in series develop successively lower pressures.

6. The apparatus of claim 4 further comprising an exhaust check valve with a cracking pressure of between 0.6 and 1.0 psi.

7. The apparatus of claim 1 wherein the bladder is substantially tube-shaped.

8. The apparatus of claim 7 wherein the bladder is constricted to deform a maximum of 0.25 to 1 inch.

9. The apparatus of claim 7 further comprising an internal check valve inside the bladder adapted to sub-divide the bladder.

10. The apparatus of claim 1 wherein a check valve comprises:
a tube having a seat and an opening;
a check comprising a spheroid adapted to block the seat;
a series of opposing helical steps in the tube proximate the opening, downstream from the check;
a retaining rod connected to the check and adapted to releasably engage two of the opposing steps; and
a filament under tensile load connecting the spheroid to the retaining rod.

11. The apparatus of claim 1 wherein the bladder is incorporated into a substantially tube-shaped sleeve.

12. The apparatus of claim 11 wherein the sleeve is circumferentially substantially inelastic and longitudinally substantially elastic.

13. The apparatus of claim 11 wherein the sleeve has a selective elasticity for modifying the pressure waves generated by the apparatus.

14. The apparatus of claim 11 wherein the sleeve further comprises a relief valve in fluid communication with the bladder.

15. The apparatus of claim 11 wherein the sleeve is incorporated into a conventional garment.

16. The apparatus of claim 1 wherein said ambient fluid is air.

17. The apparatus of claim 1 wherein the exit check valve and the entry check valve are in fluid communication.

18. A method of increasing circulation of a region of a user's body comprising the steps of:
providing an elastic bladder;
securing the bladder to bear against the region of the user's body;
engaging in skeletal movements proximate the region;
deforming the bladder;
expelling a fluid from the bladder
reforming the bladder;
taking fluid into the bladder;
forcing fluid through the bladder; and
causing bladder pressure to vary across the region.

19. The method of claim 18 including the step of forcing fluid through an entry check valve and an exit check valve.

20. An apparatus for applying air pressure to a treatment area of a user's body using bodily movement to generate said pressure, the apparatus comprising:
multiple resilient tube-shaped bladders in fluid communication in series, each of the bladders having a volume, an entry check valve for air ingress, an exit check valve for air egress, and a recharging check valve for ingress of ambient air surrounding the bladders;
a means for bearing the bladders against the treatment area;
the bladders adapted to deform responsive to the bodily movement thereby reducing the volume, and elastically reform;
the exit check valve having a cracking pressure between 0.1 and 5.0 psi;
the recharging check valve having a cracking pressure lower than the exit check valve, whereby the fluid entering and exiting the bladders due to the bodily movement generates waves of pressure across the area; and
wherein the multiple bladders connected in series are incorporated into a substantially tube-shaped sleeve and develop successively lower pressures.
